(19) United States
(12) Patent Application Publication
(10) Pub. No.: US 2009/0155596 A1
(43) Pub. Date: Jun. 18, 2009

(54) NOZZLE SEALING COMPOSITION AND METHOD

(75) Inventors: Michael A. Kropp, Cottage Grove, MN (US); Roger A. Grisle, Woodbury, MN (US); Eric G. Larson, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/955,070

(22) Filed: Dec. 12, 2007

(51) Int. Cl. C09J 5/06; C09J 163/00; B32B 37/12

(52) U.S. Cl. 428/413; 427/386; 427/508

(57) ABSTRACT

A method of applying a curable composition. The method includes providing a curable composition comprising about 10 to about 60 weight percent of one or more epoxy resins; about 20 to about 80 weight percent of one or more resins selected from polyester resins, ethyl vinyl acetate resins, thermoplastic resins, and acrylate resins; up to about 30 weight percent of one or more hydroxyl-containing compounds; and an initiator selected from a photoinitiator, a thermal initiator, and combinations thereof. The method further includes initiating cure of the curable composition.

### TECHNICAL FIELD

The present invention generally relates to adhesives suitable for sealing an orifice or a nozzle to prevent escape or contamination of a retained material. In a preferred embodiment, the adhesives remove cleanly to prevent clogging or fouling of the orifice.

### BACKGROUND

A wide variety of approaches have been used to seal an orifice to control leakage of a solid, liquid or gaseous material or prevent entry of contaminants into the material. For example, a physical cap may be used to seal a nozzle. The cap typically includes a conformable material, such as a flexible foam or an elastomer, and a mechanical structure that pushes the conformable material against the nozzles, resulting in a seal. Pressure sensitive adhesives (PSA) have also been widely used in this application. Thermoplastic materials may also be applied at temperatures above the softening point of the sealant material and then allowed to cool to room temperature to form a bond to the area adjacent the orifice and form a seal.

### SUMMARY

However, these methods for sealing an orifice have one or more disadvantages. For example, physical caps are susceptible to vibration, temperature changes and humidity fluctuations, all of which may weaken the seal between the nozzle and the cap.

As another example, designing a PSA with an appropriate level of adhesion to provide orifice sealing has proven difficult. For example, if a PSA is used that is soft and aggressively tacky, the PSA may seal the orifice sufficiently, but soft and aggressively tacky PSA's may leave a residue that may plug the orifice when the PSA is removed. In contrast, if a more rigid PSA is used, little or no residue may be left on the orifice, but a sufficient seal between the PSA and the orifice may not be formed. Additionally, even if the seal is initially sufficient, the rigidity of the PSA may cause the seal to weaken over time as restorative forces pull the PSA from contact with the orifice or the region adjacent the orifice.

The use of thermoplastic materials may require additional processing steps and relatively high processing temperatures, which may be undesirable in some applications, particularly if the region adjacent to the orifice is a polymeric material.

In one aspect, the disclosure is directed to a method of applying a curable composition. The method includes providing a curable composition comprising about 10 to about 60 weight percent of one or more epoxy resins; about 20 to about 80 weight percent of one or more resins selected from polyester resins, ethyl vinyl acetate resins, thermoplastic resins, and acrylate resins; up to about 30 weight percent of one or more hydroxyl-containing compounds; and an initiator selected from a photoinitiator, a thermal initiator, and combinations thereof. The method further includes initiating cure of the curable composition. The method then, optionally, provides a first dwell time of up to 120 minutes, where the curable composition is at least partially cured and remains tacky. The curable composition is applied to at least one nozzle having an orifice and provided with a second dwell time of up to 7 days, where the curable composition becomes substantially tack free.

In some embodiments, the method includes initiating cure using actinic radiation, and in some preferred embodiments, the actinic radiation comprises a wavelength between about 200 nm and about 700 nm.

In other embodiments, the method includes providing a curable composition on a film backing, and in some preferred embodiments, initiating cure via radiation energy applied to the curable composition through the film backing.

In yet other embodiments, the first dwell time is no greater than 5 minutes, or even no greater than 1 minute. In some embodiments the second dwell time is no greater than 24 hours.

In further embodiments, the method includes applying the curable composition to at least one nozzle having an orifice with an area no greater than about 7 mm². In some preferred embodiments, the nozzle is a component of an ink jet cartridge.

In another aspect, the disclosure is directed to a method of applying a curable composition including providing a curable composition. The curable composition may include about 10 to about 60 weight percent of one or more epoxy resins; about 20 to about 80 weight percent of one or more resins selected from polyester resins, ethyl vinyl acetate resins, thermoplastic resins, and acrylate resins; up to about 30 weight percent of one or more hydroxyl-containing compounds; and an initiator selected from a photoinitiator, a thermal initiator, and combinations thereof. The method also includes applying the curable composition to at least one nozzle having an orifice and initiating cure of the curable composition. The method further includes providing a dwell time of up to 7 days, where the curable composition becomes substantially tack free.

In some embodiments, the method includes initiating cure using actinic radiation, and in some preferred embodiments, the actinic radiation comprises a wavelength between about 200 nm and about 700 nm.

In other embodiments, the method includes providing a curable composition on a film backing, and in some preferred embodiments, initiating cure via radiation energy applied to the curable composition through the film backing.

In further embodiments, the method includes applying the curable composition to at least one nozzle having an orifice with an area no greater than about 7 mm². In some preferred embodiments, the nozzle is a component of an ink jet cartridge.

In yet another aspect, the disclosure is directed to an article including an inkjet cartridge. The article further includes a layer of curable composition. The layer of curable composition includes a first surface and a second surface opposite the first surface. The first surface is applied to a surface of the inkjet cartridge. The curable composition includes about 10 to about 60 weight percent of one or more epoxy resins; about 20 to about 80 weight percent of one or more resins selected from polyester resins, ethyl vinyl acetate resins, thermoplastic resins, and acrylate resins; and up to about 30 weight percent of one or more hydroxyl-containing compounds.

In some embodiments, the article further includes a fiber reinforcement embedded within the layer of curable composition. In other embodiments, the article further includes a backing applied to the second surface of the layer of curable composition.

In yet another embodiment, the article further includes a non-stick tab attached to the curable composition, and in some embodiments, the non-stick tab is integral to the curable composition.

In some preferred embodiments, the curable composition includes about 15 to about 40 weight percent of one or more epoxy resins; about 50 to about 80 weight percent of one or more resins selected from polyester resins, ethyl vinyl acetate resins, thermoplastic resins, and acrylate resins; and up to about 10 weight percent of one or more hydroxyl-containing compounds.

In other preferred embodiments, the curable composition includes about 20 to about 35 weight percent of one or more epoxy resins; about 60 to about 75 weight percent of one ore more resins selected from polyester resins, ethyl vinyl acetate resins, thermoplastic resins, and acrylate resins; and up to about 10 weight percent of one or more hydroxyl-containing compounds.

One application where the sealing of an orifice is becoming increasingly challenging is the sealing of ink jet cartridge nozzles. As printing speeds and resolutions increase, the size of the individual nozzles has decreased, while the number of nozzles in the cartridge has increased to allow a wider print swath. The sealant adhesive effectively seals small features and covers a larger total area. Further, the sealant adhesive should be easily removable from the nozzle, and leave substantially no adhesive residue on the nozzle or other parts of the inkjet print cartridges that may subsequently contaminate the ink or cause fouling of the nozzle opening. Also, the sealant adhesive may require chemical resistance to a wide variety of materials such as the liquid inks contained within the cartridge, i.e., there is preferably no reaction between the ink contained within the cartridge and the seal material.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic diagram illustrating a tape including a curable composition and an inkjet cartridge.

FIG. 2 is flowchart of an exemplary method of applying a curable composition to an inkjet cartridge.

FIG. 3 is a cutaway diagram illustrating the tape including the curable composition and the inkjet cartridge shown in FIG. 1.

FIG. 4 is a flowchart of another exemplary method of applying a tape including curable composition to an inkjet cartridge.

FIG. 5 is a cross-sectional view illustrating a roll of tape including a curable composition.

FIG. 6 is a schematic diagram illustrating a curable composition including a fiber reinforcement.

FIG. 7 is a schematic diagram illustrating a tape including a curable composition applied to an inkjet cartridge.

### DETAILED DESCRIPTION

In one aspect, the present disclosure is directed to a method of applying a curable composition to a nozzle or an orifice. Prior to or after application of the curable composition to the region around the orifice, the curable composition may be exposed an energy source, such as a thermal energy source or a radiation source, which initiates the curing of the curable composition and forms a partially cured composition. The partially cured composition may be aggressively tacky and compliant, and thus may form a good seal with the nozzle, orifice or an adjacent region. As the partially cured composition continues to cure, it preferably becomes less tacky and loses adhesion to the nozzle or orifice. Once the composition reaches a fully cured state, in a preferred embodiment the composition is at least substantially tack free and easily removable from the nozzle or orifice.

The curable composition may contain one or more components, each of which contributes to the overall properties of the curable composition.

### I. Epoxy Resins

The curable composition may comprise one or more epoxy resins. Useful epoxy resins include any organic compound having at least one oxirane ring that is polymerizable by a ring opening reaction. Such materials, broadly called epoxides, include both monomeric and polymeric epoxides and may be, for example, aliphatic, alicyclic, heterocyclic, cycloaliphatic, or aromatic and may further be combinations thereof. Suitable epoxides preferably do not include nitrogen atoms. Epoxides may be liquid or solid or blends thereof, blends being especially useful in providing tacky adhesive compositions. These materials generally have, on average, at least two oxirane rings per molecule and may also be referred to as “polyepoxides.” The polymeric epoxides include, but are not limited to, linear polymers having terminal epoxy groups (for example, a diglycidyl ether of a polyoxyalkylene glycol), polymers having skeletal oxirane units (for example, polybutadiene polyepoxide), and polymers having pendent epoxy groups (for example, a glycidyl methacrylate polymer or copolymer). The molecular weight of the epoxy resin may vary from about 74 to about 100,000 or more. Mixtures of various epoxy resins may also be used in the curable composition.

Suitable epoxy resins include, but are not limited to, epoxy resins that contain cyclohexene oxide groups such as the epoxycyclohexane carboxylates, typified by 3,4-epoxycyclohexylmethyl-3,4-epoxycyclohexane carboxylate; 3,4-epoxy-2-methylcyclohexylmethyl-3,4-epoxy-2-methylcyclohexane carboxylate; and bis-(3,4-epoxy-6-methylcyclohexylmethyl)adipate. For a more detailed list of useful epoxides of this nature, reference may be made to U.S. Pat. No. 3,117,099.

Other particularly suitable epoxy resins include glycidyl ether monomers and have a structure as shown below:

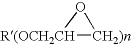

where R′ is aliphatic, such as an alkyl group, aromatic, such as an aryl group, or combinations thereof, and n is an integer from about 1 to about 6. Examples of epoxy resins having a structure as shown in the above formula include, but are not limited to, the glycidyl ethers of polyhydric phenols obtained by reacting a polyhydric phenol with an excess of chlorohydrin such as epichlorohydrin, for example, the diglycidyl ether of 2,2-bis-(4-hydroxyphenol)propane (Bisphenol A). Further examples of epoxides of this type are described in U.S. Pat. No. 3,018,262. Preferred epoxy resins include diglycidyl ethers of bisphenol A and hydrogenated bisphenol A-epichlorohydrin based epoxy resins.

A number of commercially available epoxy resins may be used. Epoxides, which are readily available, include, but are not limited to, octadecylene oxide; epichlorohydrin; styrene oxide; vinylcyclohexene oxide; glycidol; glycidyl methacrylate; diglycidyl ether of Bisphenol A (for example, those available as EPON 828, EPON 1004, and EPON 1001F from Hexion Performance Products, Houston, Tex., and DER-332 and DER-334 from Dow Chemical Co., Midland, Mich.; diglycidyl ether of bisphenol F (for example, those available as ARALDITE GY281 from Huntsman Advanced Materials Americas Inc., Los Angeles, Calif., and EPON 862 from Hexion Performance Products); vinylcyclohexane dioxide; dipentene dioxide (for example, one available as “ERL-4269” from Union Carbide Corp.); epoxidized polybutadiene (for example, one available as OXIRON 2001 from FMC Corp., Chicago, Ill.; epoxy silanes, for example, beta-3,4epoxycyclohexylethyltrimethoxy silane and gammaglycidoxypropyltrimethoxy silane, commercially available from Union Carbide; flame retardant epoxy resins (for example, one available as DER-542, a brominated bisphenol type epoxy resin available from Dow Chemical Co.); 1,4-butanediol diglycidyl ether (for example, one available as ARALDITE RD-2 from Ciba Specialty Chemicals; hydrogenated bisphenol A-epichlorohydrin based epoxy resins (for example, one available as EPONEX 1510 from Resolution Performance Products; and polyglycidyl ether of phenolformaldehyde novolak (for example, those available as DEN-431 and DEN-438 from Dow Chemical Co.).

The curable composition preferably contains one or more epoxy resins having an epoxy equivalent weight of from about 100 to about 1000. Epoxy equivalent weight is defined as the weight of resin in grams which contains one gram equivalent of epoxy, see Lee and Neville's Handbook of Epoxy Resins, Chapter 4, Characterization of Uncured Epoxy Resins, pages 4-14 and 4-21 (McGraw-Hill, Inc., 1967). More preferably, the curable composition contains one or more epoxy resins having an epoxy equivalent weight of from about 175 to about 550. Even more preferably, the curable composition contains two or more epoxy resins, wherein at least one epoxy resin has an epoxy equivalent weight of from about 175 to about 200, and at least one epoxy resin has an epoxy equivalent weight of from about 500 to about 550.

### II. Thermoplastic Polyesters

The curable composition may also include one or more thermoplastic polyesters. Suitable polyester components include, but are not limited to, amorphous and branched polyesters having a glass transition temperature (T_{g}) of not more than about 10° C., and preferably not more than about 5° C. The amorphous and branched polyester component may be differentiated from crystalline polyesters in that the amorphous and branched polyester does not display a measurable crystalline melting behavior when an 8 mg sample is subjected to a Differential Scanning Calorimetry (DSC) scan at a rate of 20° C. per minute from −60° C. to 200° C. The DSC measurement is conveniently performed using commercially available DSC equipment such as a DSC7 differential scanning calorimeter from Perkin Elmer, Norwalk, Conn.

While not displaying a melting behavior, the amorphous and branched polyester, when being subjected to a DSC scan, displays a glass transition temperature (T_{g}). The T_{g} of the amorphous and branched polyester is preferably less than about 10° C., and more preferably in the range of about −20° C. to about 5° C., and even more preferably between about −10° C. and about 5° C. The T_{g} is typically measured as the midpoint of the glass transition from the DSC scan.

The amorphous polyester component used in the curable composition includes, but is not limited to, hydroxyl and carboxyl terminated polyesters. The softening point of the amorphous and branched polyester is preferably between about 50° C. and about 150° C., more preferably between about 70° C. and about 140° C., and even more preferably between about 60° C. and about 110° C. Preferred amorphous and branched polyesters also have a number average molecular weight of from about 5,000 g/mol to about 200,000 g/mol, and more preferably from about 6,500 g/mol to about 50,000 g/mol as determined by GPC (gel permeation chromatography) in chloroform calibrated with polystyrene standards.

The amorphous and branched polyesters may be prepared by known polymerization techniques suitable for the polymerization of polyesters. Polymerizations following a step growth mechanism, e.g., polycondensations, are one preferred approach. The amorphous and branched polyester may be prepared, for example, by reacting a diol, a dicarboxylic acid or a diester equivalent and, to obtain branching, a polyol having a functionality of three or more and/or a polycarboxylic acid having a functionality of three or more. The condensation reaction in the presence of these polyols and/or polycarboxylic acids having a functionality of three or more is carried out under conditions and using stoichiometric ratios such that substantial gel formation is prevented and desired branching of the polyester is obtained.

In one embodiment, the dicarboxylic acid may be aliphatic, cycloaliphatic or aromatic. Examples of suitable aliphatic dicarboxylic acids include, but are not limited to, saturated aliphatic dicarboxylic acids, such as succinic acid and adipic acid; and unsaturated aliphatic polycarboxylic acids, such as maleic acid. Examples of aromatic dicarboxylic acids include, but are not limited to, phthalic, isophthalic and terephthalic acid.

Examples of polyfunctional carboxylic acids include, but are not limited to, aromatic polyfunctional carboxylic acids such as aromatic tricarboxylic or tetracarboxylic acids, such as trimellitic acid, trimesic acid, pyromellitic acid or benzophenonetetracarboxylic acid; and trimerized fatty acids or mixtures of dimerized and trimerized fatty acids, such as are available commercially, for example, as PRIPOL from Unichema International, New Castle, Del.

Suitable diols include, but are not limited to, aliphatic and cycloaliphatic diols. Examples of suitable aliphatic diols include, but are not limited to, α,ω-alkylenediols, such as ethylene glycol, propane-1,3-diol and butane-1,4-diol. Examples of suitable polyfunctional alcohols include, but are not limited to, 1,1,1-trimethylolethane, 1,1,1-trimethylolpropane, glycerol and pentaerythritol. Long chain diols suitable for use in the present invention include, but are not limited to, poly(oxyalkylene)glycols in which the alkylene group preferably contains from about 2 to about 9 carbon atoms (more preferably from about 2 to about 4 carbon atoms).

Reacting, for example, the dicarboxylic acids (or their diester equivalents) and the diols, polycarboxylic acids and/or polyols described above may result in amorphous and/or crystalline polyesters. An amorphous polyester compound may be easily identified by subjecting the compound to a DSC scan as described above. Amorphous rather than crystalline polyester compounds may be obtained, for example, by reacting educts with a high degree of stereoirregularity, which cannot effectively pack into crystalline structures and impart a high degree of entropy to the resulting polymer. Details on the preparation of amorphous polymers may be found, for example, in Encyclopedia of Polymer Science and Engineering, New York, N.Y. 1988, vol. 12, pp. 1-312 and the references cited therein, and in the Polymeric Materials Encyclopedia, Boca Raton 1996, vol. 8, pp. 5887-5909 and the references cited therein.

### III. Ethylene Vinyl Acetate Copolymer

The curable composition may also contain one or more thermoplastic ethylene-vinyl acetate copolymer resins. Suitable thermoplastic ethylene-vinyl acetate copolymer resins include, but are not limited to, thermoplastic ethylene-vinyl acetate copolymer resins containing at least about 28 percent by weight vinyl acetate. In one embodiment, the ethylene-vinyl acetate copolymer includes a thermoplastic copolymer containing at least about 28 percent by weight vinyl acetate, preferably at least about 40 percent by weight vinyl acetate, more preferably at least about 50 percent by weight vinyl acetate, and even more preferably at least about 60 percent by weight vinyl acetate by weight of the copolymer. In a further embodiment, the ethylene-vinyl acetate copolymer contains from about 28 to about 99 weight percent of vinyl acetate, preferably from about 40 to about 90 weight percent of vinyl acetate, more preferably from about 50 to about 90 weight percent of vinyl acetate, and even more preferably from about 60 to about 80 weight percent vinyl acetate in the copolymer.

Examples of commercially available ethylene-vinyl acetate copolymers, which may be used in the present invention include, but are not limited to, those available as ELVAX 210, 250, 260, and 265 (E. I. Du Pont de Nemours and Co., Wilmington, Del. “DuPont”) and AT Plastics 2820M EVA copolymer (AT Plastics, Inc., Brampton, Ontario, Canada) (28 weight percent vinyl acetate); ELVAX 40W (DuPont), LEVAPREN 400 (Bayer Corp., Pittsburgh, Pa.), and AT Plastics 4030M (AT Plastics, Inc., Brampton, Ontario, Canada) (40 weight percent vinyl acetate); percent vinyl acetate); LEVAPREN 600 HV (Bayer Corp.) (60 weight percent vinyl acetate); and LEVAPREN KA 8479 (Bayer Corp.) (80 weight percent vinyl acetate).

### IV. (Meth)Acrylates

The curable composition may also contain one or more thermoplastic (meth)acrylate resins. The (meth)acrylate resins may be made by a variety of polymerization methods, including bulk, solution, suspension, emulsion and photo-polymerization, The (meth)acrylate resins are preferably compatible with each other and with other adhesive constituents. The (meth)acrylate resin is a poly(meth)acrylate thermoplastic. By copolymerizing with alkene monomers, the (meth)acrylate resin may contain one or more olefin repeat units, e.g. ethylene, propylene or butylene. The molar ratio of such olefin units to (meth)acrylate repeating units is typically less than about 2, preferably in the range from about 0.5 to about 1.5.

(Meth)acrylic monomers suitable for making the thermoplastic (meth)acrylate resins used in the curable composition include, but are not limited to, monomers from the following classes:

Class A—acrylic acid esters of an alkyl alcohol (preferably a non-tertiary alcohol), wherein the alcohol contains from 1 to about 14 (preferably from about 4 to about 14) carbon atoms, including, for example, methyl acrylate, ethyl acrylate, n-butyl acrylate, t-butyl acrylate, hexyl acrylate, isooctyl acrylate, 2-ethylhexyl acrylate, isononyl acrylate, isobornyl acrylate, phenoxyethyl acrylate, decyl acrylate, and dodecyl acrylate;

Class B—methacrylic acid esters of an alkyl alcohol (preferably a non-tertiary alcohol), wherein the alcohol contains from about 1 to about 14 (preferably from about 4 to about 14) carbon atoms, including, for example, methyl methacrylate, ethyl methacrylate, n-propyl methacrylate, n-butyl methacrylate, isobutyl methacrylate and t-butyl methacrylate; and

Class C—(meth)acrylic acid monoesters of polyhydroxy alkyl alcohols such as 1,2-ethanediol, 1,2-propanediol, 1,3-propanediol, any of the various butyl diols, any of the various hexanediols, and glycerol, such that the resulting esters are referred to as hydroxyalkyl(meth)acrylates.

Bifunctional monomers may also be used to prepare the (meth)acrylates suitable for use in the curable composition. Typically, the bifunctional monomers possess at least one free radical and one cationically reactive functional group per monomer. Examples of such monomers include, but are not limited to, glycidyl(meth)acrylate, hydroxyethyl(meth)acrylate, hydroxypropyl methacrylate and hydroxybutyl acrylate.

Examples of commercially available (meth)acrylate resins include, but are not limited to, curable acrylate resins sold as HYTEMP and NIPOL, both of which are available from Zeon Chemicals Company, Inc., Louisville, Ky. The HYTEMP and NIPOL series of polyacrylates include polyacrylates such as HYTEMP 4051, and 4051EP, and NIPOL AR-31. Other commercially available acrylate resins suitable for use in the present invention include, but are not limited to, the VAMAC series of ethylene/acrylic elastomers, such as VAMAC G and VAMAC D (DuPont Packaging and Industrial Polymers, Wilmington, Del.); the LOTADER and LOTARYL (Atofina Chemicals Inc., Philadelphia, Pa.) series of acrylic elastomers and ethylene-acrylic ester copolymers, such as LOTADER 4700 and LOTARYL 35BA320, 35MA03 and 35MA05; and the EUROPRENE series of acrylic rubber, such as EUROPRENE AR53 EP, AR 156 LTR, EUROPRENE C, L and R (EniChem America Inc., Houston, Tex.).

### V. Thermoplastics

The curable composition may also contain at least one thermoplastic resin. The thermoplastic resin may be included in an amount depending on the desired properties of the curable composition prior to or after cure. One exemplary thermoplastic material includes a styrene-ethylene-butadiene-styrene block copolymer, such as the block copolymer available as Kraton G1567 from Kraton Polymers U.S. LLC, Houston, Tex.

### V. Hydroxyl-Functional or Hydroxyl-Containing Material

The curable composition may also contain at least one hydroxyl-functional or hydroxyl-containing material. As used herein, the terms “hydroxyl-functional material” and “hydroxyl-containing material” are used to represent compounds having at least one and preferably at least two hydroxyl groups. The terms “hydroxyl-functional material” and “hydroxyl-containing material” are used interchangeably. Further, the terms “hydroxyl-functional material” and “hydroxyl-containing material” do not include the amorphous and branched polyester resins described above, which may also contain one or more hydroxyl groups. Preferably, the hydroxyl-containing materials are substantially free of other “active hydrogen” containing groups such as amino and mercapto moieties. Further, the hydroxyl-containing materials are also preferably substantially free of groups that may be thermally and/or photolytically unstable so that the compounds will not decompose or liberate volatile components when exposed to actinic radiation. Preferably, the hydroxyl-containing materials contain two or more primary or secondary aliphatic hydroxyl groups (i.e., the hydroxyl group is bonded directly to a non-aromatic carbon atom). The hydroxyl group may be terminally situated, or may be pendent from a polymer or copolymer. The number average equivalent weight of the hydroxyl-containing material is preferably from about 31 to about 2500, more preferably from about 80 to about 1000, and even more preferably from about 80 to about 350.

The number average equivalent weight may be defined by the following equation:

number average equivalent weight=(m.w.)/f

where

f=functionality, that is, the average number of hydroxyl groups per molecule of hydroxyl-containing compound; and

m.w.=the number average molecular weight of the hydroxyl-containing compound.

Examples of suitable hydroxyl-containing materials for use in curable compositions include, but are not limited to, both monomeric and polymeric compounds. Suitable monomeric hydroxyl-containing materials include, but are not limited to, ethylene glycol; propylene glycol; 1,2-dihydroxypropane; 1,3-dihydroxypropane; 1,3-dihydroxybutane; 1,4-dihydroxybutane; 1,4-, 1,5-, and 1,6-dihydroxyhexane; 1,2-, 1,3-, 1,4-, 1,6-, and 1,8-dihydroxyoctane; 1,10-dihydroxydecane; 1,1,1-trimethylolethane; 1,1,1-trimethylolpropane; N,N-bis(hydroxyethyl)benzamide; castor oil; pentaerythritol; polycaprolactone; xylitol; arabitol; sorbitol; and mannitol. Suitable polymeric hydroxyl-containing materials include, but are not limited to, polyoxyalkylene polyols (e.g., polyoxyethylene and polyoxypropylene glycols and triols having an equivalent weight of from about 31 to about 2500 for diols, and from about 80 to about 350 for triols); polytetramethylene oxide glycols of varying molecular weight; and hydroxyl-terminated polyacetones.

Commercially available hydroxyl-containing materials suitable for use in the curable composition include, but are not limited to, those available as POLYMEG from Penn Specialty Chemicals, Inc., Memphis, Tenn. Suitable materials include polytetramethylene oxide glycols such as POLYMEG 650, 1000 and 2000, as well as those available as TERATHANE series from E.I. duPont de Nemours and Company, Wilmington, Del.; polytetramethylene oxide glycols such as TERATHANE 650, 1000 and 2000; POLYTHF, a polytetramethylene oxide glycol from BASF Corp. (Charlotte, N.C.); the BUTVAR series (available from Solutia, Inc., St. Louis, Mo.) of polyvinylacetal resins such as BUTVAR B-72A, 8-73, 8-76, 8-90 and 8-98; the TONE series (available from Union Carbide, Danbury, Conn.) of polycaprolactone polyols such as TONE 0200, 0210, 0230, 0240, and 0260; the DESMOPHEN series (available from Bayer Corporation, Pittsburg, Pa.) of saturated polyester polyols such as DESMOPHEN 631A 75, 650A 65, 651A 65, 670A 80, 680 70, 800, 1100, 1150, 1300 75, 1300 75 BA, 1652A, 1700, 1800, R 12A, R 221 75, A 160 SN, A 365, A 450 BA/X, 550 U, 1600 U, 1900 U, 1915 U, 1920 U, NH 1220, NH 1420, and NH 1521; VORANOL 234-630 (a trimethylol propane) from Dow Chemical Company (Midland, Mich.); VORANOL 230-238 (a glycerol polypropylene oxide adduct) from Dow Chemical Company; the SYNFAC series (from Milliken Chemical, Spartanburg, S.C.) of polyoxyalkylated bisphenol A's such as SYNFAC 8009, 773240, 8024, 8027, 8026, and 8031; and the ARCOL series (from Arco Chemical Co., Los Angeles, Calif.) of polyoxypropylene polyols such as ARCOL 425, 1025, 2025, 42, 112, 168, and 240; and bisphenol-A extended polyols such as SIMULSOL BPHE, BPIE, BPJE, BPLE, BPNE, BPRE, BPHP, BPIP, BPRP and BPUP from Seppic (Paris, France). Other useful commercially available hydroxyl-containing materials include those described in U.S. Pat. No. 5,436,063, which is incorporated by reference.

A particularly useful class of hydroxyl-containing compounds is the polyoxyalkylene polyols. Examples of this class of hydroxyl containing compounds include, but are not limited to, polyoxyethylene and polyoxypropylene glycols; polyoxyethylene and polyoxypropylene triols; polytetramethylene oxide glycols; and polyoxyalkylated bisphenol A's. The polyoxyalkylene polyols are particularly suitable for retarding the curing reaction so that the curing time of the curable composition can be increased. As used herein, the term “curing time” is used to mean the period of time after a cure of the curable composition has been initiated, until the curable composition has lost substantially all of its tack. Another preferred class of hydroxyl-containing compounds for use in the curable composition is hydroxy-containing phenoxy resins. Particularly preferred phenoxy resins are those derived from the polymerization of a di-glycidyl bisphenol compound. Typically, the phenoxy resin has a number average molecular weight of less than 50,000, preferably in the range of about 10,000 to about 20,000. Commercially available phenoxy resins suitable for use in the present invention include, but are not limited to, those available as PAPHEN PKHP-200 from Phenoxy Associates (Rock Hill, S.C.). It has been found that the addition of a phenoxy resin to the curable composition may improve the dynamic overlap shear strength, decrease the cold flow and/or improve the impact resistance of the curable composition.

### VI. Curing Agent

The term “curing agent” is used broadly to include not only those materials that are conventionally regarded as curing agents for epoxy resins, but also those materials that catalyze epoxy resin cure, as well as those materials that may act as both curing agent and catalyst. Preferred curing agents for the epoxy resin include room temperature curing agents, heat-activated curing agents, and photolytic curing agents, and combinations thereof. The curing agents preferably react at temperatures of between about room temperature and about 150° C., more preferably between about room temperature and about 50° C. Photolytic curing agents, i.e., photoinitiators, are most preferred. Photoinitiators for use in the curable composition are preferably activated by photochemical means, such as by actinic radiation (i.e., radiation having a wavelength in the ultraviolet or visible portion of the electromagnetic spectrum).

The curable composition may include an effective amount of one or more photoinitiator, which amount varies depending on the light source(s) and the degree of exposure. Preferably, the curable composition includes one or more photoinitiator in an amount of up to about 3 weight percent, based on the total weight of the composition. More preferably, the curable composition includes one or more photoinitiator in an amount of from about 0.5 weight percent to about 2 weight percent, based on the total weight of the composition, when a photoinitiator is present. Even more preferably, the curable composition includes one or more photoinitiators in an amount of from about 1 weight percent to about 2 weight percent, based on the total weight of the composition, when a photoinitiator is present.

Photoinitiators suitable for use in the compositions of the invention include cationic photoinitiators. Useful cationic photoinitiators include energy-activatable salts, the cations of which can have initiating, curing, or catalytic properties when activated by actinic radiation. The energy-activatable salts can have a photochemically-reactive cationic portion and a nonnucleophilic anion. A broad class of cationic photoinitiators can be used, including those described in U.S. Pat. No. 4,250,311 (Crivello); U.S. Pat. No. 3,708,296 (Schlesinger); U.S. Pat. No. 4,069,055 (Crivello); U.S. Pat. No. 4,216,288 (Crivello); U.S. Pat. No. 5,084,586 (Farooq); U.S. Pat. No. 5,124,417 (Farooq); U.S. Pat. No. 4,985,340 (Palazzotto et al.); and U.S. Pat. No. 5,089,536 (Palazzotto), the descriptions of which are incorporated herein by reference in their entirety.

Suitable cations include organic onium cations, organometallic complex cations, and the like. Useful organic onium cations include, for example, those described in U.S. Pat. No. 4,250,311 (Crivello), U.S. Pat. No. 3,708,296 (Sheldon), U.S. Pat. No. 4,069,055 (Crivello), U.S. Pat. No. 4,216,288 (Crivello), U.S. Pat. No. 5,084,586 (Farooq), and U.S. Pat. No. 5,124,417 (Farooq), the descriptions of which are incorporated herein by reference in their entirety. Such cations include those of aliphatic and aromatic Group IVA-VIIA (CAS version) centered onium salts.

Preferred are I-, S-, P-, and C-centered onium salts (for example, sulfoxonium, diaryliodonium, triarylsulfonium, carbonium, and phosphonium). Most preferred are I- and S-centered onium salts (for example, diaryliodonium and triarylsulfonium). The aryl group of such salts can be an unsubstituted or substituted aromatic moiety having up to about four independently selected substituents. The substituents preferably have fewer than about 30 carbon atoms and up to about 10 heteroatoms selected from N, S, non-peroxidic O, P, As, Si, Sn, B, Ge, Te, Se, and the like.

Useful organometallic complex cations include those described in U.S. Pat. No. 4,985,340 (Palazzotto et al.), the descriptions of which are incorporated herein by reference in their entirety.

Suitable anions, X, for use as the counterion to the above-described cations include those represented by the formula: DQᵣ, wherein D is a metal from Groups IB to VIIB and VIII or a metal or metalloid from Groups IIIA to VA of the Periodic Table of Elements (CAS notation); Q is a halogen atom, a hydroxyl group, a substituted or unsubstituted phenyl group, or a substituted or unsubstituted alkyl group; and r is an integer of 1 to 6. Preferably, D is selected from metals such as copper, zinc, titanium, vanadium, chromium, aluminum, tin, gallium, zirconium, indium, manganese, iron, cobalt, and nickel, or from metalloids such as boron, antimony, arsenic, and phosphorus. Preferably, Q is a halogen atom (more preferably, chlorine or fluorine). Representative examples of such anions include B(phenyl)₄⁻, B(phenyl)₃(alkyl)⁻ (where alkyl can be ethyl, propyl, butyl, hexyl, and the like), BF₄⁻, PF₆⁻, AsF₆⁻, SbF₆⁻, FeCl₄⁻, SnCl₅⁻, SbF₅OH⁻, AlCl₄⁻, AlF₆⁻, GaCl₄⁻, InF₄⁻, TiF₆⁻, ZrF₆⁻, B(C₆F₅)₄⁻, and B(C₆F₃(CF₃)₂)₄⁻. Preferred anions include BF₄⁻, PF₆⁻, AsF₆⁻, SbF₆⁻, SbF₅OH⁻, B(C₆F₅)₄⁻, B(C₆F₃(CF₃)₂)₄⁻, and B(phenyl)₄⁻.

Other anions, X, useful in suitable photoinitiators include CH₃SO₃⁻, CF₃SO₃⁻, C₆H₅SO₃⁻, p-toluenesulfonate, p-chlorobenzenesulfonate, and the like. Preferred anions include BF₄⁻, PF₆⁻, SbF₆⁻, SbF₅OH⁻, AsF₆⁻, SbCl₆⁻, CF₃SO₃⁻, C(SO₂CF₃)₃⁻, and N(SO₂CF₃)₂⁻, with C(SO₂CF₃)₃⁻ and N(SO₂CF₃)₂⁻ being most preferred.

Various sensitizers known in the art can be added to the curable composition to expand and/or shift the light spectrum at which the photoinitiators become active, i.e., the frequency of light at which they initiate cure of the epoxy resin. Known accelerators may also be useful when combined with the appropriate photoinitiator in the composition.

Suitable commercially available initiators include, but are not limited to, aromatic sulfonium complex salts available as FX-512 (Minnesota Mining and Manufacturing Company, St. Paul, Minn.); CD-1012 and CD-1010 (Sartomer, Exton, Pa.); UVOX UVI-6974, an aromatic sulfonium complex salt (Union Carbide Corp., Danbury, Conn.); and IRGACURE 261, a cationic organometallic complex salt (Ciba Specialty Chemicals, Basel, Switzerland).

Useful thermal curing agents include those selected from the group consisting of Lewis acids and Lewis acid complexes including aluminum trichloride; aluminum tribromide; boron trifluoride; boron trichloride; antimony pentafluoride; titanium tetrafluoride; and boron trifluoride and boron trichloride complexes including, for example, BF₃.diethylamine and a BCl₃.amine complex available as OMICURE BC-120 from CVC Specialty Chemicals, Inc., Maple Shade, N.J.

Additional useful thermal curing agents include aliphatic and aromatic amines including, for example, dimethylpropylamine, pyridine, dimethylaminopyridine, and dimethylbenzylamine; imidazoles including, for example, 2-ethylimidazole, and 2-ethyl-4-methylimidazole (available as IMICURE EMI-2,4 from Air Products, Allentown, Pa.); hydrazides including, for example, aminodihydrazide; guanidines including, for example, tetramethyl guanidine; and dicyandiamide.

The amount of thermal curing agents used in the curable composition may depend on whether the curing agent becomes an intergral part of the polymerized epoxy or whether it acts as a catalyst for the polymerization. Curing agents that become an integral part of the polymerizaton are typically used in higher concentration than those that are catalysts. In this case, the mole ratio of cure agent functional groups to epoxide ring functional groups is preferably no greater than about one. A preferred range of the mole ratio of cure agent functional groups to epoxide ring functional groups is about 0.1 to 1. If the thermal curing agent is being employed as a catalyst, the curable composition may contain up to about 10% by weight catalyst, preferably up to about 5% by weight catalyst. A preferred amount of catalyst may range from about 0.5% to about 3% by weight.

### VIII. Other Additives

The curable composition may further comprise up to about 50 weight percent, preferably, up to about 10 percent, of various additives such as fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, and the like, such as silica, glass, clay, talc, pigments, colorants, glass beads or bubbles, and antioxidants, to reduce the weight and/or cost of the composition, adjust viscosity, and/or enhance one or more physical properties of the resulting cured or partially cured composition.

In one embodiment, an additive in the form of acrylic core/shell particles is added to the curable composition as an impact modifier. The acrylic core/shell particles may be added in an amount of up to about 20 weight percent based on the total weight of the composition. Preferably, the acrylic core/shell particles are added in an amount of up to about 10 weight percent based on the total weight of the composition. One commercially available product suitable for use in the composition is an acrylic core/shell impact modifier available as ZEON F-351, from Zeon Chemicals Co. Inc. (Louisville, Ky.).

### EXEMPLARY EMBODIMENTS OF THE COMPOSITION

In one embodiment, the curable composition includes (i) about 10 to about 60 weight percent of one or more epoxy resins, (ii) about 20 to about 80 weight percent of one or more resins selected from polyester resins, ethyl vinyl acetate resins, and (meth)acrylate resins, (iii) up to about 30 weight percent of one or more hydroxyl-containing compounds, (iv) up to about 10 weight percent of one or more photoinitiators, and, optionally, (v) up to about 50 weight percent of one or more additives, wherein all weight percentages are based on a total weight of the composition.

In another embodiment, the curable composition includes (i) about 15 to about 40 weight percent of one or more epoxy resins, (ii) about 50 to about 80 weight percent of one or more resins selected from polyester resins, ethyl vinyl acetate resins, and (meth)acrylate resins, (iii) up to about 10 weight percent of one or more hydroxyl-containing compounds, (iv) up to about 5 weight percent of one or more photoinitiators, and, optionally, (v) up to about 10 weight percent of one or more additives, wherein all weight percentages are based on the total weight of the composition.

In another embodiment, the curable composition includes (i) about 20 to about 35 weight percent of one or more epoxy resins, (ii) about 60 to about 75 weight percent of polyester resin, (iii) up to about 5 weight percent of one or more hydroxyl-containing compounds, and (iv) about 0.5 weight percent to about 3 weight percent of one or more photoinitiators, wherein all weight percentages are based on the total weight of the composition.

### Application of Curable Composition to Inkjet Cartridge

As described briefly above, the curable composition may be applied to a wide range of articles that include orifices to seal the orifices. As one example, the following discussion is directed to application of the curable composition to inkjet cartridges including at least one orifice comprising one or more nozzle. However, it will be understood that the curable compositions are not limited in application to inkjet cartridges, but may be applied to seal any surface including one or more orifice.

Inkjet print cartridges typically include an ink reservoir that is fluidically coupled to a substrate, which is attached to a nozzle layer. The nozzle layer contains one or more nozzles from which the ink is ejected during printing. During shipment and storage, the nozzle or nozzles are preferably sealed to prevent evaporation or leaking of the ink from the nozzle, and also to prevent dust or debris from entering the nozzle. Again, the following example is intended to illustrate one possible use of the curable composition and tape, and is not intended to be limiting.

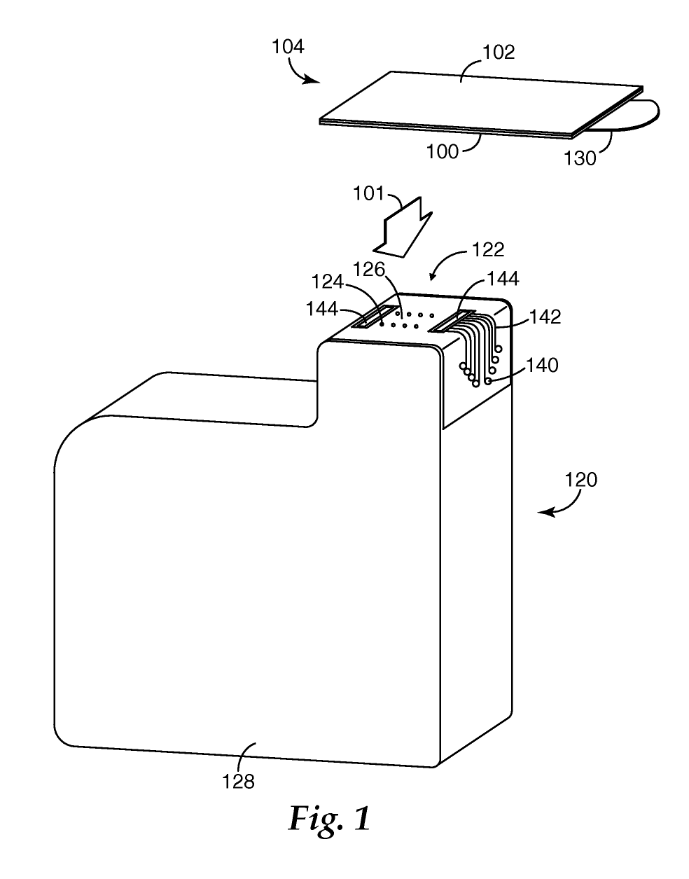

Referring to FIG. 1, an exemplary embodiment of an inkjet cartridge 120 includes a reservoir 128 that contains an ink which is supplied to a substrate (not shown) that is secured to the back of a nozzle layer 126. The substrate (not shown), the nozzle layer 126, nozzles 124, and a flexible circuit 122 form what is generally referred to as an inkjet cartridge head. In those embodiments which do not utilize an integrated nozzle layer and flexible circuit, the substrate, the nozzle layer and the nozzles are generally referred to as the inkjet cartridge head.

The nozzle layer 126 contains one or more nozzles 124 through which ink is ejected. Each of the nozzles may be a small, such as having an area of no greater than about 7 mm². The nozzle layer 126 may be formed of metal, polymer, glass, or another suitable material such as ceramic. Preferably, the nozzle layer 126 is formed from a polymer such as polyimide, polyester, polyethylene naphthalate (PEN), epoxy, or polycarbonate. Examples of commercially available nozzle layer materials include a polyimide film available from DuPont as Kapton, a polyimide material available from Ube Industries, Ltd. (Japan) as Upilex, and a photoimagible epoxy available from MicroChem Corp. as NANO SU-8. In an alternate embodiment, the nozzle layer 126 is formed from a metal such as a nickel base enclosed by a thin gold, palladium, tantalum, or rhodium layer.

The flexible circuit 122 of the exemplary embodiment is a polymer film and includes electrical traces 142 connected to electrical contacts 140. The electrical traces 142 are routed from the electrical contacts 140 to bond pads on the substrate (not shown) to provide electrical connection for the inkjet cartridge 120. When the flexible circuit 122 and nozzle layer 126 are integrated as shown in FIG. 1, raised encapsulation beads 144 (typically an epoxy) are dispensed within a window formed in the integrated flexible circuit 122 and nozzle layer 126. The encapsulation beads 144 protect and encapsulate the electrical trace 142 and bond pad electrical connections on the substrate. In an alternate embodiment, when nozzle layer 126 is not integrated into flexible circuit 122 the encapsulation beads 144 are dispensed along the edge of nozzle layer 126 and the edge of the substrate to provide the protection function for the electrical connections to the substrate.

Once the reservoir 128 is filled with fluid, a nozzle 124 is at least partially sealed to prevent leakage and/or to prevent contamination of the ink. The curable composition 100 described above is then applied to at least one nozzle in an amount sufficient to at least partially seal a nozzle, preferably to fully seal all nozzles 124.

In one embodiment, for example, the curable composition 100 is placed on a backing 102 to form a tape 104 (FIG. 1). In other embodiments, the curable composition 100 may not necessarily be provided on a backing 102. For example, the curable composition 100 may be a self-supporting film, or may include a fiber reinforcement to support the composition 100 (as shown in FIG. 6). In a preferred embodiment, the tape 104 is initially provided on a roll, cut to the appropriate length, and aligned with the inkjet cartridge 120 such that tape 104 will fully cover nozzles 124. Tape 104 may also be provided with a non-sticking tab 130, commonly referred to as a pull-tab, to facilitate gripping and removal of tape 104. The non-sticking tab 130 may be integral to backing 102, may be a separate structure from backing 102 and curable composition 100, or may be integral with curable composition 100. In embodiments where non-sticking tab 130 is integral with curable composition 100, the composition 100 may be die cut to form the desired geometry (e.g., the shape of a tape with a pull-tab). Tape 104 is then applied onto the inkjet cartridge 120 in the direction of arrow 101.

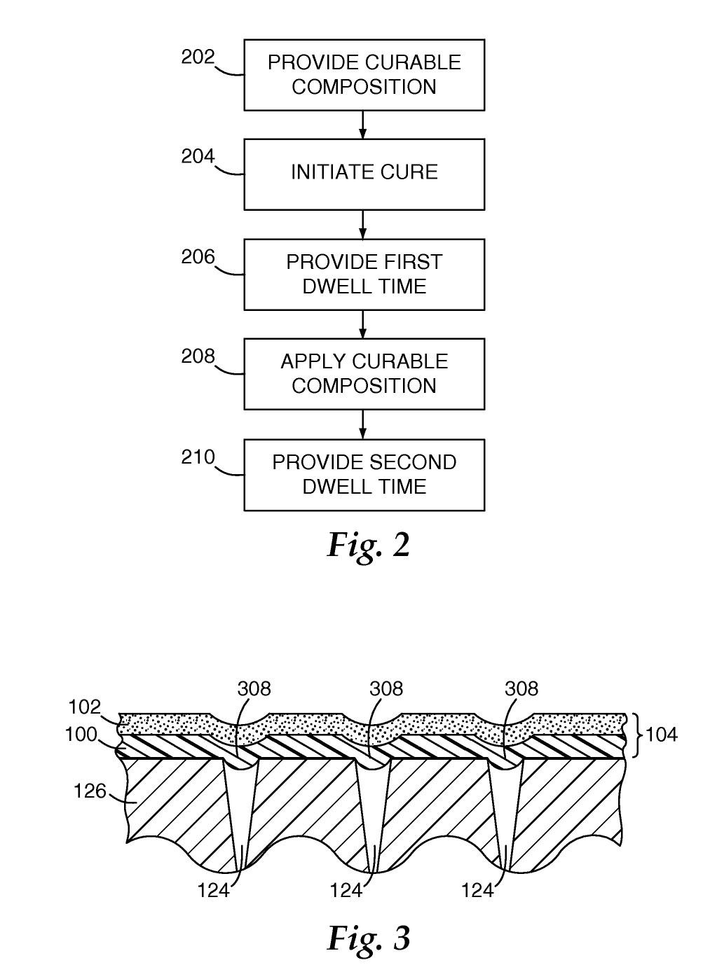

In some embodiments, such as the method illustrated in FIG. 2, prior to the application of the tape 104 to the inkjet cartridge 120, the curable composition 100 is provided (202) and exposed to a dose of actinic radiation sufficient to initiate cure of the curable composition (204). Curing of the curable composition 100 may be initiated by exposing the curable composition 100 to a light source that emits actinic radiation. Curing may be accomplished by exposing curable composition 100 to actinic radiation through backing 102, or exposing the side of curable composition 100 opposite backing 102 to actinic radiation. Suitable sources of radiation include, but are not limited to, mercury lamps, xenon lamps, carbon arc lamps, tungsten filament lamps, sunlight, etc. Although the focus of the present invention is directed to initiating cure by actinic radiation, it should be noted that other means of initiation may be used in the present invention including, but not limited to, electron beam and gamma radiation, thermal initiation, and the like; however, initiation by actinic radiation is generally preferred. More preferably, curing of the curable composition 100 is initiated by exposing the curable composition 100 to a light source, which emits radiation having a wavelength of from about 200 nm to about 700 nm. Even more preferably, the cure of the curable composition 100 is initiated by exposing the curable film to a light source, which emits radiation having a wavelength of from about 300 nm to about 470 nm. Even more preferably, the cure of the curable composition 100 is initiated by exposing the curable film to a light source, which emits radiation having a wavelength of from about 310 nm to about 380 nm. In one embodiment of the present invention, the radiation source is preferably a medium pressure mercury arc lamp.

Exposure times may vary widely, and in some embodiments may range from less than about 1 second to about 10 minutes or more to provide a total energy exposure of from about 0.05 Joules/square centimeter (J/cm²) to about 4.0 Joules/square centimeter (J/cm²) depending upon both the amount and the type of reactants involved, the initiation type (e.g., thermal or radiation) and source, the distance from the initiation source, the type of radiation employed (e.g., the wavelength and wavelength range), and the thickness of the layer of curable composition 100 to be cured. The rate of cure initiation tends to increase with increasing amounts of initiator at a given thermal exposure, light exposure or irradiation. The rate of cure initiation also increases with increased thermal or radiation intensity. Desirably, exposure times are from less than about 1 second to about 3 seconds to provide a total energy exposure of from about 0.05.0 J/cm² to about 3.8 J/cm² when initiating via radiation. More desirably, exposure times are less than about 1 second to provide a total energy exposure of from about 0.1 J/cm² to about 1.80 J/cm² when initiating via radiation. The initiation of cure preferably leads to partial cure of the curable composition 100 while providing a dwell time, as will be described below.

Once the curable composition 100 is exposed to the radiation source, the curing process is initiated and the curable composition 100 is at least partially cured. The curing of the curable composition 100 may be generally divided into two periods of time, known as dwell times. During the first dwell time, the curable composition 100 is at least partially cured, but not completely cured, and remains tacky. The first dwell time may last no greater than 1 minute or no greater than 5 minutes, or the first dwell time may last significantly longer, such as up to 120 minutes. The curable composition 100 may be applied (206) to the inkjet cartridge 120 at any time during the first dwell time, or in some embodiments, the first dwell time may not be provided. Eventually, the curable composition 100 preferably achieves at least a substantially tack-free, i.e. non-tacky, condition, more preferably a completely tack-free condition. A substantially tack-free condition may be achieved under ambient conditions in about 7 days or as little as no greater than 24 hours, depending upon the intensity of the radiation source, the radiation exposure time, the concentration of the photoinitiator, and the particular ingredients, which comprise the curable composition 100. Additionally, to decrease the time it takes for the curable composition to reach a substantially tack-free condition, a post cure may be applied to the curable composition after cure initiation and attachment to the nozzle. The post cure may include exposure of the curable composition to additional thermal and/or actinic radiation.

In some cases, it may be advantageous to retard the cure rate of the curable composition 100. For example, curable compositions 100 that contain a polyether polyol typically have a slower cure rate. The slower cure rate may allow the curable composition 100 to remain tacky for a longer period of time, which may improve the seal of the inkjet nozzle or nozzles 124.

Once the curable composition 100 has been exposed to the radiation source and has formed a partially cured film (e.g., at the end of or during the first dwell time), it may be applied (208) to the inkjet cartridge 120. The partially cured film is preferably applied to the inkjet cartridge 120 shortly after being exposed to the actinic radiation. The rate of the curing reaction is finite, and the entire curable composition 100 does not cure instantaneously. At low cure levels, the curable composition 100 may remain highly tacky and pliable, and thus may be able to adhere tightly to the inkjet cartridge head and form a close-fitting seal over the inkjet nozzle or nozzle 124.

Because tape 104 is applied to the inkjet cartridge 120 when curable composition 100 is in a partially cured state, tape 104 may be sufficiently flexible to allow tape 104 to deform at least a small distance into the inkjet nozzle or nozzles 124, as shown in FIG. 3. In FIG. 3 the curable composition 100 has been pressed onto the nozzle layer 126 of the inkjet print cartridge. Depressions 308 may form in the tape 104 at locations corresponding to the nozzles 124. In addition, the curable composition 100 preferably has sufficient cohesive strength, and adhesive strength to backing 102, to prevent the curable composition 100 from breaking where the depressions 308 are formed. Thus, this prevents contamination of the nozzles 124 by a residue from the curable composition 100 upon removal of tape 104.

Once the curable composition 100 is applied to the inkjet cartridge 120, a second dwell time is provided (210), during which the curable composition 100 may harden and become substantially less tacky. This may enable the tape 104 to be easily removed. Additionally, because the curable composition 100 is at least substantially tack-free when it is removed from the inkjet cartridge, in preferred embodiments the curable composition 100 should not leave any unwanted residue behind on the nozzle layer 126 or in the nozzles 124.

Backing 102 may serve to support the curable composition 100 before, during and after cure. Curable composition 100 preferably adheres to backing 102 more strongly than it adheres to the substrate on which it is placed. Adhesion between backing 102 and curable composition 100 may be enhanced by a surface treatment, such as corona treatment and the like. Backing 102 may be any suitable material including, but not limited to, polymers and mixtures of polymers such as PET, polyethylene, and the like; paper, and the like.

Backing 102 may also facilitate the printing of images or text on tape 104. Printed images or text may include, for example, logos, graphics, use instructions, and the like. Printed images may be printed by the manufacturer, or by the user.

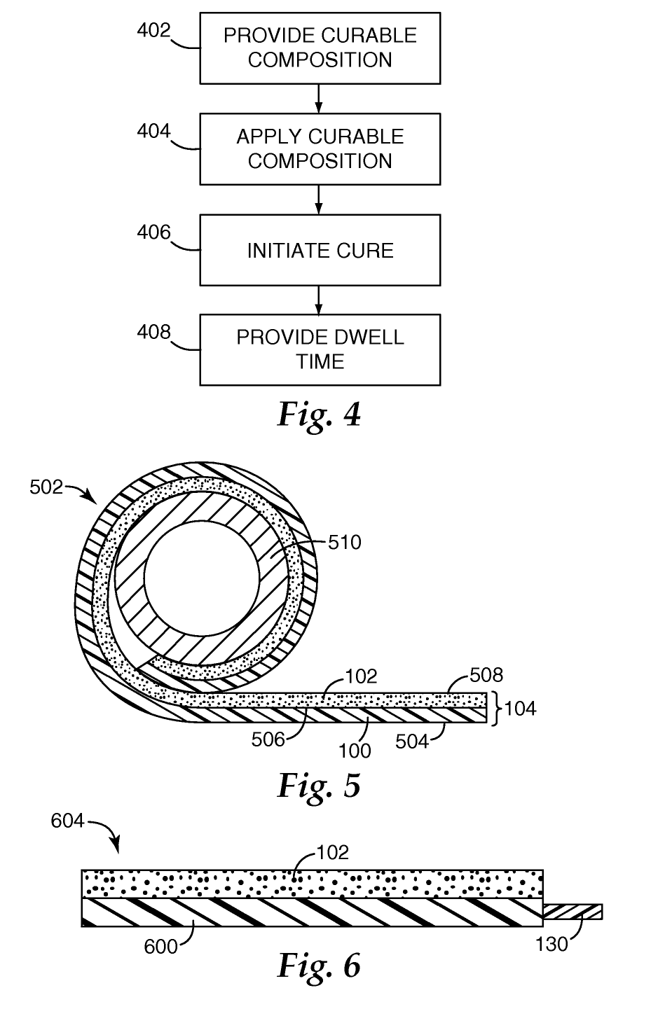

FIG. 4 shows another method of applying the curable composition 100 to an inkjet cartridge 120. First, the curable composition 100 is provided (402). The curable composition 100 may be provided as a self-supporting film, or may be provided in roll form with a backing. Additionally, the curable composition 100 may be provided in a form that includes a fiber reinforcement, as described in regard to FIG. 6.

The curable composition 100 is then applied (404) to an inkjet cartridge 120 prior to initiation of cure.

Following application of the curable composition 100 to the inkjet cartridge 120, cure of the curable composition 100 is initiated (406). As was described in further detail above, the cure may be initiated using thermal energy, electron beam, gamma radiation, or actinic radiation, and actinic radiation is preferred. In this embodiment, the cure is typically initiated through the backing of the tape 104, when a backing is present. However, any useful method of initiating cure may be utilized.

Once cure is initiated, a dwell time is again provided (408), during which cure of the curable composition 100 proceeds. During the dwell time, the curable composition 100 continues to cure, and changes from a tacky film to a substantially, preferably fully, non-tacky film. Upon completion of the dwell time, the curable composition 100 may be substantially non-tacky and tape 104 easily removed from the inkjet cartridge 120 without leaving a residue or film that may contaminate nozzles 124. The dwell time may again range from as little as no greater than 24 hours to as much as up to 7 days. Additionally, to decrease the time it takes for the curable composition to reach a substantially non-tacky condition, a post cure may be applied to the curable composition after attachment to the nozzle and cure initiation. The post cure may include exposure of the curable composition to additional thermal and/or actinic radiation.

FIG. 5 shows a cross-sectional view of a roll 502 of tape 104 on core 510. A roll 502 of tape 104 may be a convenient way of storing or distributing tape 104. Surface 508 of backing 102 preferably does not adhere to surface 504 of curable composition 100. In an embodiment where a surface treatment, such as corona treatment, is necessary to promote adhesion between backing 102 and curable composition 100 at interface 506, surface 504 of curable composition 100 may naturally not adhere to surface 508 of backing. However, in embodiments where adhesion between backing 102 and curable composition 100 at interface 506 is sufficiently strong without a surface treatment, a surface treatment to lower adhesion may be necessary on surface 508 of backing 102. Suitable surface treatments may vary depending on the composition of backing 102 and curable composition 100, but may include, for example, applying a thin film of material with anti-adhesion properties on surface 508 of backing 102.

FIG. 6 shows an alternative embodiment of tape 604 including curable layer 600 with a fiber reinforcement. Curable layer 600 may include any of the above-described radiation-curable compositions. In certain of these compositions, curable layer 600 may possess a sufficiently low viscosity at room temperature that layer 600 may flow at room temperature (cold flow), or may not be readily manufactured due low melt strength, for example. Addition of a fiber reinforcement embedded within curable layer 600 may protect against cold flow. The fiber reinforcement may be woven or nonwoven, and may comprise, for example, a polymer such as polyester, polyolefin, and the like; an organic material such as cotton; or inorganic materials such as glass, carbon, and ceramic. The fiber reinforcement is preferably chosen to not impact the curability of the curable layer 600 upon exposure to actinic radiation. Additionally, the thickness of the fiber reinforcement is preferably selected so that the curable composition fully encapsulates the fiber reinforcement.

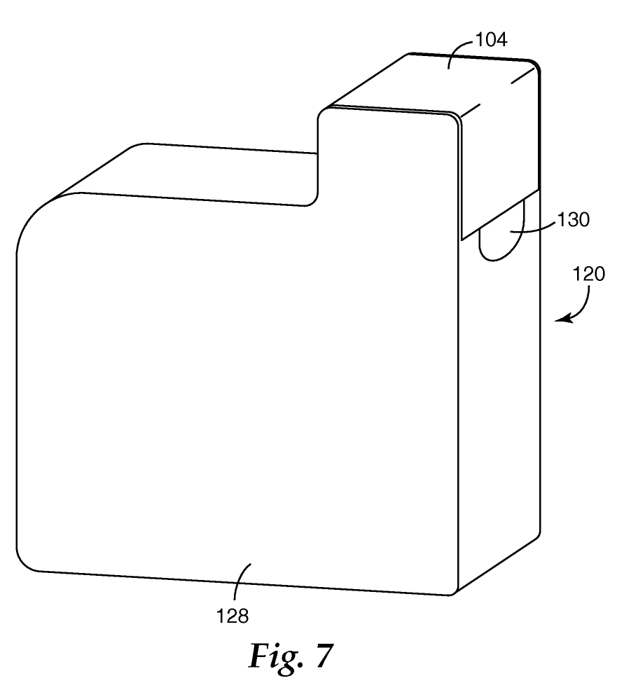

Referring to FIG. 7, an inkjet cartridge 120 is shown with the tape 104 applied. The tape 104 includes an optional non-sticking tab 130, which allows the end consumer a better grip on the tape 104 when removing the tape 104 from the inkjet cartridge 128. The tape 104 has been pushed down onto the nozzle layer (not shown in FIG. 7) and the flexible circuit (not shown in FIG. 7).

### EXAMPLES

### Preparation of Examples 1-5

TABLE 1
List of Materials Used

| Name | Source | Description |
|---|---|---|
| Kraton G 1657 | Kraton Polymers U.X. LLC, | Hydrogenated styrene- |
| | Houston, TX | butadiene block |
| | | copolymer |
| Elvax 40W | DuPont Company, | Ethylene Vinyl |
| | Wilmington, DE | Acetate copolymer |
| Epon 828 | Hexion Specialty Chemicals, | Bisphenol A diglycidyl |
| | Columbus, OH | ether |
| Kraton L207 | Kraton Polymers U.X. LLC, | Epoxidized |
| | Houston, TX | polybutadiene |
| Pripol 2033 | Uniqema, Chicago, IL | Polyol derived from |
| | | dimerized fatty acid |
| Voranol 230-238 | Dow Polyurethanes, | Polyol |
| | Midland, MI | |
| Cyracure | Union Carbide Corporation, | Cationic initiator |
| UVI-6974 | Piscataway, NJ | |
| Eponex 1510 | Hexion Specialty Chemicals, | Epoxy resin |
| | Columbus, OH | |

The adhesive compositions listed in Table 2 were prepared by mixing the individual components (Table 1) together with stirring. The adhesive solutions were spread with a knife coater onto a silicone treated PET film (release liner) and the coating was heated at 80° C. for 10 minutes in a forced air oven to produce a 40 μm thick adhesive layer. These adhesive coatings were laminated to either a 50 μm thick polypropylene film or to a 25 μm thick PET film for further testing.

TABLE 2

| | Exam- | Exam- | Exam- | | |
|---|---|---|---|---|---|
| | ple 1 | ple 2 | ple 3 | Example 4 | Example 5 |
| Kraton G1657 (30% | 22.3 | 25 | 25 | — | — |
| by wt. in toluene) | | | | | |
| Elvax 40W (30% by | — | — | — | 22.3 | 25 |
| wt. in toluene) | | | | | |
| Epon 828 | — | — | — | 3 | 2.25 |
| Kraton L207 | 3 | 2.25 | 1.25 | — | — |
| Propol 2033 | 0.3 | 0.25 | 0.25 | — | — |
| Voranol 230-238 | — | — | — | 0.3 | 0.25 |
| Cyracure UVI-6974 | 0.1 | 0.09 | 0.09 | 0.1 | 0.09 |
| Eponex 1510 | — | — | 1 | — | — |

### Examples 1-5

The laminated adhesives were irradiated with a total absorbed dose of 0.2 J/cm² with a UV light with an output wavelength centered around 350 nm. After cure initiation via UV light irradiation, exothermic energy from the irradiated adhesive was measured by Differential Scanning Calorimetry (DSC). There was no appreciable decrease in measured amount of exothermic energy from the irradiated adhesive for about 30 minutes after UV irradiation, but after 24 hours at room temperature the exothermic energy was greatly reduced. The measured exothermic energies for examples 1 and 3 are listed in Table 3. The UV irradiated tapes were laminated to pen cartridges to seal the ink nozzles. After aging at 60° C. for 24 hours, all the tapes made from the samples shown in Table 2 removed easily and cleanly from the cartridges and there was no contamination in the nozzles or anywhere else on the cartridges. Also, there was no evidence of ink leaking from the nozzles.

### Example 6

Radiation-curable transfer tape (UViSBT 9284, 10 mils (254 μm) thick, available from 3M Company, St. Paul, Minn.), Example 6, were irradiated under a UV blacklight (118 volt, 60 cycle AC from Eclipse Electric Co., Minneapolis, Minn.) using various exposure times. The transfer tapes were then applied by hand to empty inkjet cartridges over the inkjet nozzle area, and the backing was removed to leave a film. The films were in contact with die, flex and pen body materials. The samples were stored at room temperature for 24 hours, and the adhesion level was determined qualitatively by removing the films by hand. Table 4 shows results for this evaluation. All irradiated films were pliable, non-tacky and self-supporting upon removal from the inkjet cartridges.

After aging and removal of the films, the ink nozzles were inspected for residual adhesive contamination. Visual inspection with a microscope revealed no visible contamination.

TABLE 3

| Time after UV Irradiation | Example 1 | Example 3 |
|---|---|---|
| (min) | Energy (J/g) | Energy (J/g) |
| 0 | 11.4 | 21.5 |
| 10 | 11.1 | 21.7 |
| 30 | 10.0 | 19.4 |
| 60 | 6.6 | 13.4 |
| 240 | 1.9 | 4.5 |
| 1440 | 0.14 | 1.0 |

TABLE 4

| | Exposure Time | Initial | | Final |
|---|---|---|---|---|
| SAMPLE | (min) | Adhesion | Final Adhesion | Properties |
| 1 | 1 | 5 | 2 | Tack free/hard |
| 2 | 2 | 5 | 2 | Tack free/hard |
| 3 | 3 | 5 | 1 | Tack free/hard |
| 4 | 4 | 5 | 1 | Tack free/hard |
| 5 | 5 | 3 | 1 | Tack free/hard |
| C1 | 0 | 5 | 5 | Tacky/soft |

Adhesion - 5 = high; 1 = low

Various embodiments of the invention have been described. These and other embodiments are within the scope of the following claims.

We claim:

1. A method of applying a curable composition comprising:
a) providing a curable composition comprising:
(i) about 10 to about 60 weight percent of one or more epoxy resins;
(ii) about 20 to about 80 weight percent of one or more resins selected from polyester resins, ethyl vinyl acetate resins, thermoplastic resins, and acrylate resins;
(iii) up to about 30 weight percent of one or more hydroxyl-containing compounds; and
(iv) an initiator selected from a photoinitiator, a thermal initiator, and a combination thereof;
b) initiating cure of the curable composition;
c) optionally, providing a first dwell time of up to 120 minutes, wherein the curable composition is at least partially cured and remains tacky;
d) applying the curable composition to at least one nozzle having an orifice;
e) providing a second dwell time of up to 7 days, wherein the curable composition becomes substantially tack free.

2. The method of claim 1, wherein initiating cure comprises initiating cure using actinic radiation.

3. The method of claim 2, wherein the actinic radiation comprises a wavelength between about 200 nm to 700 nm.

4. The method of claim 1, wherein providing a curable composition comprises providing a curable composition on a film backing.

5. The method of claim 4, wherein initiating cure comprises initiating cure via radiation energy applied to the curable composition through the film backing.

6. The method of claim 1, wherein providing a first dwell time comprises providing a first dwell time that is no greater than 5 minutes.

7. The method of claim 1, wherein providing a first dwell time comprises providing a first dwell time that is no greater than 1 minute.

8. The method of claim 1, wherein providing a second dwell time comprises providing a second dwell time that is no greater than 24 hours.

9. The method of claim 1, wherein applying the curable composition to at least one nozzle having an orifice comprises applying the curable composition to at least one nozzle having an orifice, wherein the area of the orifice is no greater than about 7 mm².

10. The method of claim 1, wherein applying the curable composition to at least one nozzle having an orifice comprises applying the curable composition to at least one nozzle having an orifice, wherein the nozzle is a component of an ink jet cartridge.

11. A method of applying a curable composition comprising:
a) providing a curable composition comprising:
(i) about 10 to about 60 weight percent of one or more epoxy resins;
(ii) about 20 to about 80 weight percent of one or more resins selected from polyester resins, ethyl vinyl acetate resins, thermoplastic resins, and acrylate resins;
(iii) up to about 30 weight percent of one or more hydroxyl-containing compounds; and
(iv) an initiator selected from a photoinitiator, a thermal initiator, and combinations thereof;
b) applying the curable composition to at least one nozzle having an orifice;
c) initiating cure of the curable composition;
d), providing a dwell time of up to 7 days, wherein the curable composition becomes substantially tack free.

12. The method of claim 11, wherein initiating cure comprises initiating cure using actinic radiation.

13. The method of claim 12, wherein the actinic radiation comprises a wavelength between about 200 nm and about 700 nm.

14. The method of claim 13, wherein providing a curable composition comprises providing a curable composition on a film backing.

15. The method of claim 11, wherein initiating cure comprises initiating cure via radiation energy applied to the curable composition through the film backing.

16. The method of claim 11, wherein providing a dwell time comprises providing a dwell time that is no greater than 24 hours.

17. The method of claim 11, wherein applying the curable composition to at least one nozzle having an orifice comprises applying the curable composition to at least one nozzle having an orifice, wherein the area of the orifice is no greater than about 7 mm².

18. The method of claim 11, wherein applying the curable composition to at least one nozzle having an orifice comprises applying the curable composition to at least one nozzle having an orifice, wherein the nozzle is a component of an ink jet cartridge.

19. An article comprising:
an inkjet cartridge; and
a layer of curable composition comprising a first surface and a second surface opposite the first surface, wherein the first surface is applied to a surface of the inkjet cartridge, the radiation-curable composition comprising:
(i) about 10 to about 60 weight percent of one or more epoxy resins;
(ii) about 20 to about 80 weight percent of one or more resins selected from polyester resins, ethyl vinyl acetate resins, and acrylate resins; and
(iii) up to about 30 weight percent of one or more hydroxyl-containing compounds.

20. The article of claim 19, further comprising a fiber reinforcement embedded within the layer of curable composition.

21. The article of claim 19, further comprising a backing applied to the second surface of the layer of curable composition.

22. The article of claim 19, further comprising a non-stick tab attached to the curable composition.

23. The article of claim 22, wherein the non-stick tab is integral to the curable composition.

24. The article of claim 19, wherein the curable composition comprises:
(i) about 15 to about 40 weight percent of one or more epoxy resins;
(ii) about 50 to about 80 weight percent of one or more resins selected from polyester resins, ethyl vinyl acetate resins, thermoplastic resins, and acrylate resins; and
(iii) up to about 10 weight percent of one or more hydroxyl-containing compounds.

25. The article of claim 19, wherein the curable composition comprises:
(i) about 20 to about 35 weight percent of one or more epoxy resins;
(ii) about 60 to about 75 weight percent of one ore more resins selected from polyester resins, ethyl vinyl acetate resins, thermoplastic resins, and acrylate resins; and
(iii) up to about 10 weight percent of one or more hydroxyl-containing compounds.
